(19) United States
(12) Patent Application Publication
(10) Pub. No.: US 2026/0051820 A1
(43) Pub. Date: Feb. 19, 2026

(54) DYNAMIC COMPENSATION CLAMP FOR CURRENT MODE CONTROL

(71) Applicant: Texas Instruments Incorporated, Dallas, TX (US)

(72) Inventor: David Megaw, Gilbert, AZ (US)

(21) Appl. No.: 18/805,771

(22) Filed: Aug. 15, 2024

(51) Int. Cl. H02M 3/158; H02M 1/00; H02M 1/08

(52) U.S. Cl. CPC H02M 3/158; H02M 1/0009; H02M 1/0025; H02M 1/08

(57) ABSTRACT

Described embodiments include a voltage regulator circuit with an amplifier having inputs coupled to a feedback voltage terminal and a reference voltage terminal. A comparator has a first comparator input coupled to the amplifier output, a second comparator input and a comparator output. A current sense circuit provides a current sense output proportional to an output current. A waveform generator is coupled between the second comparator input and ground. A first latch input is coupled to the comparator output. A clock generator is coupled between a second latch input and ground. A clamp circuit has a first clamp input coupled to the current sense output, a second clamp input coupled to a fixed voltage source, and a clamp output coupled to the first comparator input. The clamp circuit limits the first comparator input voltage to a clamp voltage that varies responsive to the current sense output.

### BACKGROUND

This description relates to voltage clamping circuits, particularly for compensation circuits such as those used for current mode control in switching voltage regulators. In cases where a switching voltage regulator includes a current mode control loop, the switching voltage regulator may produce a significantly large voltage spike on the output voltage line when the switching voltage regulator recovers from a voltage dropout condition or an overcurrent condition.

The voltage spike can be caused by the use of a fixed voltage compensation clamp on the voltage control loop error amplifier when the output voltage falls below the specified output voltage, and the subsequent relatively large change in the control loop compensation voltage when recovering from the dropout or overcurrent condition. Previous solutions to the output voltage overshoot problem when coming out of a dropout condition include responding to and limiting the output voltage by controlling the high side and low side drive transistors. However, this can lead to sustained oscillations in the output voltage due to an inherent race condition between the output voltage and the compensation loop.

### SUMMARY

In a first example, a voltage regulator circuit includes an amplifier having first and second amplifier inputs and an amplifier output. The first amplifier input is coupled to a feedback voltage terminal, and the second amplifier input is coupled to a reference voltage terminal. A comparator has first and second comparator inputs and a comparator output. The first comparator input is coupled to the amplifier output.

A current sense circuit has a current sense input and a current sense output. The current sense input is coupled to an output voltage terminal, and the current sense output is coupled to the second comparator input. The current sense circuit is configured to provide, at the current sense output, a voltage that is proportional to a current being delivered to the output voltage terminal.

A waveform generator is coupled between the second comparator input and a ground terminal. The waveform generator is configurable to provide a waveform signal at a switching frequency. A latch has first and second latch inputs and first and second latch outputs. The first latch input is coupled to the comparator output. A clock generator is coupled between the second latch input and the ground terminal. The clock generator is configurable to provide a clock signal at the switching frequency.

A voltage clamp circuit has first and second voltage clamp inputs and a voltage clamp output. The first voltage clamp input is coupled to the current sense output. The second voltage clamp input is coupled to a fixed voltage source. The voltage clamp output is coupled to the first comparator input. The voltage clamp circuit is configurable to limit a voltage at the first comparator input to a clamp voltage that varies in response to a voltage at the current sense output.

In a second example, a method for controlling a voltage converter circuit includes connecting a first field effect transistor (FET) in series with a second FET between an input voltage terminal and a ground terminal. An inductor is coupled between a switching terminal and an output voltage terminal, wherein the output voltage terminal provides an output voltage, and the first and second FETs are connected at the switching terminal.

A compensation current is generated at a compensation terminal. The compensation current that is proportional to a difference between a reference voltage and a voltage that is proportional to the output voltage, which produces a compensation voltage that tracks a current through the inductor. A waveform signal and a clock signal that are in-phase and have the same frequency are each generated. The compensation voltage is limited to not exceed a clamping voltage. The clamping voltage is equal to a sum of a maximum voltage of the waveform signal, a minimum compensation voltage required to trigger switching of the first and second FETs, and a current sense voltage that is proportional to a current through the inductor.

The compensation voltage is compared to a comparison voltage using a comparator having a comparator output. The comparison voltage is equal to a sum of the maximum voltage of the waveform signal and the minimum compensation voltage that is required to trigger switching of the first and second FETs. The first and second FETs are controlled responsive to the comparator output.

### BRIEF DESCRIPTION OF THE DRAWINGS

FIG. 1 shows a schematic diagram for an example switching voltage regulator having a fixed voltage clamp on the compensation signal.

FIG. 2 shows a timing diagram for the compensation voltage and output voltage signals in an example switching voltage regulator having a fixed voltage clamp circuit.

FIG. 3 shows a graph of voltage versus time for signals of an example dynamic voltage clamp circuit.

FIG. 4 shows a schematic diagram for an example switching voltage regulator having a dynamic voltage clamp circuit.

### DETAILED DESCRIPTION

In this description, the same reference numbers depict same or similar (by function and/or structure) features. The drawings are not necessarily drawn to scale.

Switching voltage regulators that include a current mode control loop may produce a significantly large voltage spike at the output voltage terminal when the switching voltage regulator recovers from a dropout condition or an overcurrent condition. One common condition that can cause a large voltage spike at the output voltage terminal is recovery of the voltage regulator after the output voltage terminal has been short-circuited to ground.

A second common condition that can cause a large voltage spike at the output voltage terminal is the switching voltage regulator attempting to deliver more current to the load than the switching voltage regulator is capable of providing. This condition can produce a sag in the output voltage. A third condition that can cause a large voltage spike at the output voltage terminal is the input voltage dropping below the specified nominal output voltage. In this case, the output voltage V_{OUT} will follow the input voltage while the switching voltage regulator is operating at the maximum duty cycle it is allowed to operate at.

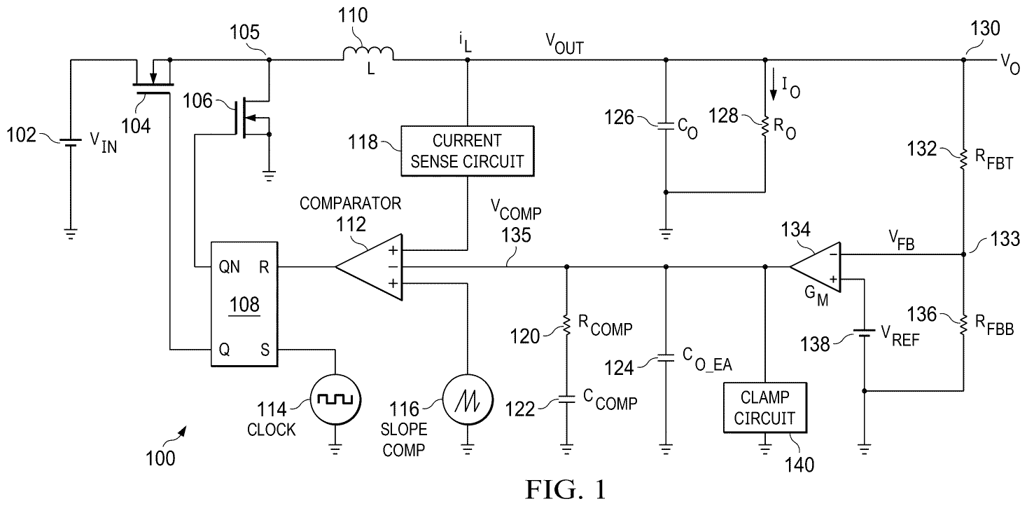

FIG. 1 shows a schematic diagram for an example switching voltage regulator 100. Input voltage source 102 provides an input voltage V_{IN}. Transistor 104 is coupled between input voltage source 102 and a switching terminal 105. Transistor 106 is coupled between the switching terminal 105 and a ground terminal. In this example, transistor 104 operates as the high side switch and transistor 106 operates as the low side switch of switching voltage regulator 100. Inductor 110 is coupled between the switching terminal 105 and an output voltage terminal V_{O} 130. A current I_{L} runs through inductor 110. Capacitor C_{O} 126 and resistor R_{O} 128 are coupled in parallel between the output voltage terminal V_{O} 130 and the ground terminal. Capacitor C_{O} 126 and resistor R_{O} 128 represent the load capacitance and load resistance, respectively, on the output.

Resistor 132 is coupled between the output voltage terminal V_{O} 130 and an output voltage feedback terminal 133. Resistor 136 is coupled between the output voltage feedback terminal 133 and the ground terminal. Resistors 132 and 136 form a voltage divider on the output voltage V_{O}. The voltage at the output voltage feedback terminal 133 is V_{FB}. The inverting input of amplifier 134 is coupled to the output voltage feedback terminal 133 and receives the voltage V_{FB}. Reference voltage source 138 is coupled between the noninverting input of amplifier 134 and the ground terminal, and provides a voltage V_{REF}. The voltage V_{REF} is a reference voltage that is set equal to the voltage V_{FB} at the output voltage feedback terminal 133 when the output voltage V_{O} 130 is at a specified nominal output voltage.

In at least one example, amplifier 134 is a transconductance amplifier. Amplifier 134 compares the voltage V_{FB} at the output voltage feedback terminal 133 to the reference voltage V_{REF}, and provides at its output a signal that is proportional to the difference between V_{FB} and V_{REF}. Clamp circuit 140 is coupled between the output of amplifier 134 and the ground terminal. The purpose of clamp circuit 140 is to ensure that the compensation voltage V_{COMP} 135 does not exceed a specific fixed clamp voltage V_{Clamp}. Clamp circuit 140 could be a zener diode, or could be any other type of circuit that provides a fixed maximum voltage and is capable of pulling down any voltage higher than the fixed maximum voltage to the fixed maximum voltage.

Current sense circuit 118 is coupled between the output voltage terminal V_{O} 130 and a first noninverting input of comparator 112. Current sense circuit 118 senses the current flowing through inductor 110 and provides a voltage proportional to the current through inductor 110 to the first noninverting input of comparator 112. Slope Comp generator 116 is coupled between a second noninverting input of comparator 112 and the ground terminal. Slope Comp generator 116 provides a slope compensation waveform at the frequency of the switching voltage regulator. In at least one example, the slope compensation waveform is a sawtooth waveform.

The current sense signal provided by current sense circuit 118 is summed with the slope compensation waveform from Slope Comp generator 116 to provide the noninverting input to comparator 112. The output of amplifier 134 is coupled to the inverting input of comparator 112 providing the signal V_{COMP} 135 at the inverting input of comparator 112. Resistor R_{COMP} 120 is coupled between the output of amplifier 134 and a first terminal of capacitor C_{COMP} 122. A second terminal of capacitor C_{COMP} 122 is coupled to the ground terminal. Capacitor C_{O_EA} 124 is coupled between the output of amplifier 134 and the ground terminal. Resistor R_{COMP} 120, capacitor C_{COMP} 122, and capacitor C_{O_EA} 124 form a type II compensation filter, which is commonly used in current mode control circuits.

Capacitor C_{COMP} 122 sets the crossover frequency of the type II compensation filter. Resistor R_{COMP} 120 is coupled in series with capacitor C_{COMP} 122 and provides a zero in the type II compensation filter. Capacitor C_{O_EA} 124 usually has a small capacitance value (e.g. 10 pF), and is used primarily for filtering out high frequency noise rather than for providing stability to the control loop. Stability for the control loop is provided primarily by the capacitor C_{COMP} 122 and resistor R_{COMP} 120.

Comparator 112 is shown as having 3 inputs, but could also be shown as having a summing terminal coupled to a single noninverting input to comparator 112 in which the current sense signal from current sense circuit 118 is summed with the slope compensation waveform from Slope Comp generator 116, and the summed signal being provided as the noninverting input to comparator 112. Comparator 112 compares this summed signal to the compensation voltage V_{COMP} 135, and provides an output signal to the Reset input of latch 108. In at least one example, latch 108 is an RS flip-flop.

Clock generator 114 is coupled between the Set input of latch 108 and the ground terminal. Clock generator 114 provides a clock signal having the same frequency as the switching frequency of switching voltage regulator 100. In at least one example, the clock signal is a square-wave signal. The clock signal produced by clock generator 114 has the same frequency and is in phase with the slope compensation waveform produced by Slope Comp generator 116.

The Q output of latch 108 is coupled to the control terminal of transistor 104 and controls the turning on and turning off of transistor 104. The QN output of latch 108, which is an inverted version of the Q output, is coupled to the control terminal of transistor 106 and controls the turning on and turning off of transistor 106. In some examples, an additional first drive stage (not shown) and second drive stage (not shown) are coupled between the Q output of latch 108 and the control terminal of transistor 104, and between the QN output of latch 108 and the control terminal of transistor 106, respectively, to ensure that adequate drive is provided to the control terminals of transistor 104 and 106, respectively, to turn them on.

A problem can occur in switching voltage regulators that use peak current mode control if the switching duty cycle exceeds 50%. Subharmonic oscillations that can make the control loop unstable may occur when the switching duty cycle exceeds 50%. To allow the current mode control voltage regulator to operate with any duty cycle, including a duty cycle higher than 50%, some type of slope compensation may be included to help avoid subharmonic oscillations.

The Slope Comp signal provided by the Slope Comp generator 116 in switching voltage regulator 100 helps to avoid that subharmonic oscillations and ensure that the switching voltage regulator remains stable across all duty cycles. The Slope Comp signal may be a sawtooth waveform having the same frequency as the switching frequency of the voltage regulator. When the Slope Comp signal from Slope Comp generator 116 is turned on, it is summed with the output of current sense circuit 118, then compared to the compensation voltage V_{COMP} 135.

When transistor 104 turns on, the Slope Comp signal begins to increase, eventually causing comparator 112 to trip and provide a logic high at its output. The logic high signal that is provided at the Reset input of latch 108 resets latch 108, which pulls down the voltage at the gate of transistor 104. Consequently, latch 108 remains in reset and transistor 104 remains turned off until the next cycle when transistor 104 turns on again, and then the cycle repeats.

Whenever the current through inductor 110 becomes high enough that the voltage at the output of current sense circuit 118 becomes higher than the compensation voltage V_{COMP} 135, the output of comparator 112 resets the latch 108. A continuously running clock signal provided by clock generator 114 is provided to the Set input of latch 108. The clock signal may be a square-wave signal, or may have some other waveform. This clock signal triggers turning on transistor 104. A rising edge of the clock signal sets latch 108. Transistor 104 then turns on and the current through inductor 110 begins to increase. The Slope Comp signal provided by Slope Comp generator 116 also begins to increase.

When the sum of the Slope Comp signal and the output voltage of current sense circuit 118 equals the compensation voltage V_{COMP} 135, the output of comparator 112 goes high and resets latch 108. Resetting latch 108 turns off transistor 104. This control loop regulates the peak current through inductor 110. The cycle then repeats beginning with the rising edge of the clock signal from clock generator 114. Transistor 104 is then turned on and remains on until the current through inductor 110 becomes high enough to turn off transistor 104.

Clamp circuit 140 is coupled between the output of amplifier 134 and ground. Clamp circuit 140 provides an upper limit or clamp voltage V_{Clamp} that the compensation voltage V_{COMP} 135 cannot rise above. As long as switching voltage regulator 100 is operating in a nominal controlled state, the compensation voltage V_{COMP} 135 reflects the magnitude of the current through inductor 110. While in this controlled condition, the compensation voltage V_{COMP} 135 and the current sense voltage at the output of current sense circuit 118 track each other. A higher compensation voltage V_{COMP} 135 equates to a higher current through inductor 110.

However, there are conditions that can cause the voltage regulator control loop to go open loop, and the voltage regulation control loop is no longer closed and under control. When that happens, the V_{COMP} voltage can go to either the high side voltage rail or to the low side voltage rail, depending on whether the output voltage is lower or higher, respectively, than its specified nominal value. Examples of a condition that can cause the voltage regulator control loop to go open loop include the output voltage terminal being short-circuited to ground, the voltage regulator attempting to deliver more current to the load than it is capable of providing which causes the output voltage level to sag, and the input voltage being at or below the specified nominal output voltage.

The voltage regulator control loop is regulated by providing a reference voltage V_{REF} 138 and comparing it to an output feedback voltage V_{FB} 133 that is provided by a resistor divider on the output voltage V_{O} 130 formed by resistors 132 and 136. Ideally, the output feedback voltage V_{FB} 133 is always virtually equal to the reference voltage V_{REF} 138. If the output feedback voltage V_{FB} 133 is lower than the reference voltage V_{REF} 138, then the compensation voltage V_{COMP} 135 begins to increase. In the absence of clamp circuit 140, the compensation voltage V_{COMP} 135 would rise to and remain at the upper supply rail voltage, creating an open loop condition in the voltage control loop.

The clamp voltage V_{Clamp}, which sets an upper limit on the compensation voltage V_{COMP} 135, should be set high enough that it does not affect performance of the switching voltage regulator during normal operation. However, to ensure that the clamp voltage V_{Clamp} is high enough to not affect performance of the switching voltage regulator under all normal conditions, the clamp voltage V_{Clamp} is usually set well above the voltage it would be at when the voltage control loop is closed.

If the output feedback voltage V_{FB} 133 remains lower than the reference voltage V_{REF} 138 for long enough time, the compensation voltage V_{COMP} 135 will rise to the clamp voltage and remain there for as long as the voltage regulator remains in that state. When coming out of that state, a long recovery period may be required before the voltage regulator control loop can regain full control. The recovery period is due to the time needed to charge or discharge capacitors C_{COMP} 122 and C_{O_EA} 124. During the recovery period, the output voltage V_{O} 130 may overshoot significantly. In one example, the output voltage V_{O} 130 overshoots 60% higher than its specified nominal voltage.

The overshoot on output voltage V_{O} 130 occurs in this case because the compensation voltage V_{COMP} 135 is charged via amplifier 134 until it reaches the clamp voltage V_{Clamp} while in the dropout condition. Then, when the input voltage V_{IN} 102 increases enough to become higher than the specified nominal output voltage and the dropout condition ends, the output voltage V_{O} 130 may overshoot because the voltage regulator control loop has not yet recovered and taken control due to the recovery time required for the compensation voltage V_{COMP} 135 to go from the clamp voltage V_{Clamp} to the voltage it needs to be at to accurately control the output voltage V_{O} 130.

If the clamp voltage V_{Clamp} is set at a fixed value, the fixed value should be high enough to prevent the clamp from disturbing the voltage control loop during normal operation. The compensation voltage V_{COMP} 135 also depends on the magnitude of the current through inductor 110 and the duty cycle of the switching voltage regulator. In one example case, the voltage range of the compensation voltage V_{COMP} 135 while operating in regulation varied from 0.6V to 1.6V.

So, if V_{Clamp} is set at a single fixed clamping voltage, that clamping voltage must be set high enough too not interfere with normal operation under any condition. For example, if the compensation voltage V_{COMP} 135 normally runs around 800 mV during normal operation, that voltage may charge to around 2.1V when a dropout condition occurs. Then, when the voltage regulator comes out of that dropout condition, the compensation voltage V_{COMP} 135 must work its way back down from 2.1V to 800 mV before the voltage control loop can regain control. This recovery time may take tens or hundreds of microseconds. During that recovery time, the output voltage V_{OUT} can overshoot significantly. The recovery time required for the change in voltage of the compensation voltage V_{COMP} 135 causes the output voltage V_{O} 130 overshoot problem.

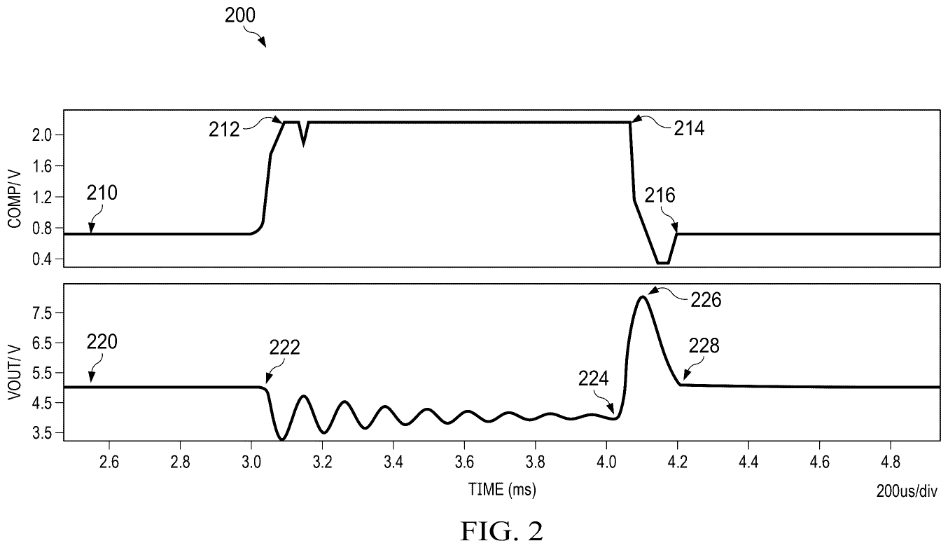

FIG. 2 shows a timing diagram 200 for the compensation voltage and output voltage in an example switching voltage regulator having a fixed voltage clamp circuit. Curve 210 is a plot of voltage versus time for the compensation voltage V_{COMP} 135 in switching voltage regulator 100. Curve 220 is a plot of voltage versus time for the output voltage V_{O} 130 in switching voltage regulator 100.

At 222, the output voltage V_{OUT} drops in response to the switching voltage regulator going into a dropout condition due to the input voltage V_{IN} 102 falling below the specified nominal output voltage V_{OUT(nom)}. When the input voltage V_{IN} 102 falls below the specified nominal output voltage V_{OUT(nom)}, it causes the output feedback voltage V_{FB} 133 to fall below the reference voltage V_{REF} 138, which causes the compensation voltage V_{COMP} 135 to rise to its upper clamp voltage at 212. During the period from 222 to 224, the voltage control loop is out of control, so the output voltage V_{OUT} is not being properly regulated and will follow the input voltage V_{IN}. The highest voltage that the output voltage V_{OUT} can reach in a buck voltage regulator is equal to the input voltage V_{IN}.

At 224, the input voltage V_{IN} recovers and the switching voltage regulator comes out of the dropout condition. The output voltage V_{OUT} rises, but does not stop rising at the specified nominal output voltage V_{OUT(nom)}. Instead, the output voltage V_{OUT} overshoots at 226 to a peak voltage significantly higher than the specified nominal output voltage V_{OUT(nom)}. As the switching voltage regulator comes out of the dropout condition, the compensation voltage V_{COMP} 135 begins to drop from the clamp voltage at 214. However, a recovery time is required for the compensation voltage V_{COMP} 135 to discharge from the clamp voltage to its steady-state value at 216. The time between 214 and 216 is the recovery time.

When the compensation voltage V_{COMP} 135 reaches its steady-state value, the voltage control loop regains control, and the output voltage V_{OUT} will reach the specified nominal output voltage V_{OUT(nom)} at 228. In this case, the compensation voltage V_{COMP} 135 has to discharge from 2.1 V to 0.65V, which requires a recovery time of over 150 microseconds. During this recovery time, the output voltage V_{OUT} overshot its specified nominal output voltage of 5V by more than 3V. This overshoot problem occurred during the recovery time and was due to the significant voltage difference between the clamp voltage and the steady-state voltage of the compensation voltage V_{COMP} 135.

One possible solution to the overshoot problem is to make the clamp voltage dynamic, adjusting to changing conditions rather than setting the clamp voltage at a fixed voltage. Adequate information is provided by the switching voltage regulator circuit to determine and generate a dynamic compensation clamp voltage that limits the amount of voltage discharge required on the compensation voltage V_{COMP} 135, which helps to limit the overshoot on the output voltage V_{O} 130.

The clamp voltage V_{Clamp} can be set to dynamically remain just above the voltage that the compensation voltage V_{COMP} should be at during normal operation. This helps ensure that the voltage clamp has no effect on circuit performance during normal operation, but clamps the compensation voltage V_{COMP} when the switching voltage regulator gets into a dropout condition. This allows the compensation voltage V_{COMP} to recover from a dropout condition more quickly. The compensation voltage V_{COMP} can recover more quickly because it only has to move a smaller amount (e.g. 100 mV instead of 1-2V) than it does with a fixed voltage clamp circuit.

The clamp voltage V_{Clamp} that limits the compensation voltage V_{COMP} can be set so that recovery from a dropout condition can occur more quickly with less disruption to the output voltage V_{OUT} by setting the clamp voltage V_{Clamp} to dynamically track and remain just above the compensation voltage V_{COMP}. Then, if the switching voltage regulator goes into a dropout condition, the compensation voltage V_{COMP} recovers more quickly coming out of the dropout condition because the compensation voltage V_{COMP} is not required to discharge as much to regain control of the voltage control loop.

This can be done by making the clamp voltage V_{Clamp} dependent on the sensed current flowing through inductor 110, which is sensed by the current sense circuit 118. A minimum compensation voltage V_{COMP} 135 is necessary to trigger switching in the voltage regulator. In one example case, this minimum compensation voltage, V_{COMP_Offset}, to trigger switching was determined to be 600 mV. However, in other systems, V_{COMP_Offset} may be at a different voltage. The maximum voltage of the Slope Comp signal from Slope Comp generator 116 when running at or near 100% duty cycle, V_{MAX_Slope_Comp}, can be determined for any given system. In one example system, V_{MAX_Slope_Comp} was determined to be 340 mV. However, the magnitude for V_{MAX_Slope_Comp} can be different in other systems.

The base voltage for the compensation voltage clamp, V_{Base_Clamp}, can be determined by adding the minimum compensation voltage, V_{COMP_Offset} to the maximum slope compensation voltage V_{MAX_Slope_Comp}. In some examples, a safety margin voltage, V_{margin}, may be added to ensure that the clamp on the compensation voltage never interferes with normal operation of the voltage regulator. In cases where a safety margin voltage is added, the base voltage for the compensation voltage clamp V_{Base_Clamp} is equal to the sum of the minimum compensation voltage V_{COMP_Offset}, the maximum slope compensation voltage when running at 100% duty cycle V_{MAX_Slope_Comp}, and the safety margin voltage V_{margin}.

To determine the clamp voltage, the inductor current ripple is sensed and added to the base voltage for the compensation voltage clamp V_{Base_Clamp}. In at least one example system, the sensed inductor current signal is rectified before being added to the base voltage for the compensation voltage clamp V_{Base_Clamp}. Rectifying the inductor current signal may improve performance because it is the peak inductor current that is being regulated. So, the compensation voltage V_{COMP} should remain higher than the peak. Ideally, the clamp voltage V_{Clamp} tracks the peak inductor current because the information from the remainder of the slope compensation waveform is not needed. So, a more accurate clamp voltage can be determined by rectifying the sensed inductor current signal prior to adding it to the base voltage for the compensation voltage clamp V_{Base_Clamp}, but, this is not required.

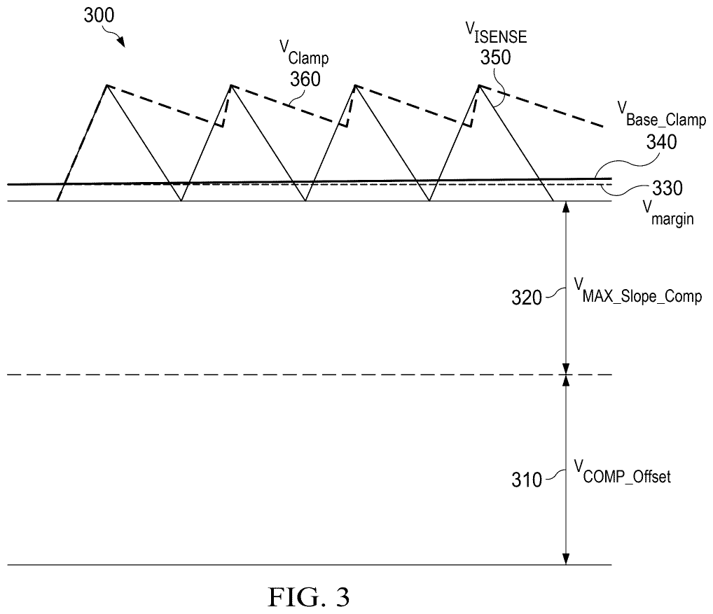

FIG. 3 shows a graph 300 of voltage versus time for signals of an example dynamic voltage clamp circuit. Voltage 310 is V_{COMP_Offset} which is the minimum compensation voltage V_{COMP} 135 required to trigger switching in the voltage regulator. Voltage 320 is V_{MAX_Slope_Comp}, which is the maximum voltage of the Slope Comp signal from Slope Comp generator 116 when the voltage regulator is running at 100% duty cycle. Voltage 330 is V_{margin}, which is a safety margin voltage that may be added in some cases to ensure that the clamp on the compensation voltage never interferes with normal operation of the voltage regulator. The addition of a voltage V_{margin} 330 is optional, and V_{margin} 330 may be zero in some systems.

Voltage 340 is V_{Base_Clamp}, which is equal to the sum of V_{COMP_Offset} 310, V_{MAX_Slope_Comp} 320, and the safety margin voltage V_{margin} 330. Curve 350 is a plot of voltage versus time for V_{ISENSE}, which is the current sense voltage from current sense circuit 118 and is proportional to the current through inductor 110. Curve 360 is a plot of voltage versus time for V_{Clamp}, which is the upper limit or clamp voltage that the compensation voltage V_{COMP} 135 cannot rise above. The clamp voltage V_{Clamp} 360 is the sum of the base voltage for the compensation voltage clamp V_{Base_Clamp} 340 and the current sense voltage V_{ISENSE} 350. The clamp voltage V_{Clamp} 360 is set by clamp circuit 140.

The clamp voltage V_{Clamp} 360 is equal to a fixed value, V_{Base_Clamp} 340, plus a scaled version of the sensed inductor current, V_{ISENSE} 350. The clamp voltage V_{Clamp} 360 is set to remain higher than the compensation voltage V_{COMP} 135 so that it never interferes with normal operation of the voltage regulator. The clamp voltage V_{Clamp} 360 is set just above the voltage it needs to be so that if the voltage regulator goes into a situation where the control loop goes open loop and the compensation voltage V_{COMP} 135 rises to the clamp voltage V_{Clamp} 360, it does not have a large voltage to discharge to regain control and regulate the output voltage.

The clamp voltage V_{Clamp} 360 follows and rides just above the compensation voltage V_{COMP} 135. The clamp voltage V_{Clamp} 360 is dependent on the sensed inductor current. If the voltage regulator is operating at a lower output current and the inductor current is lower, then the clamp voltage V_{Clamp} 360 is at a lower voltage. Likewise, if the voltage regulator is operating at a higher output current and the inductor current is higher, then the clamp voltage V_{Clamp} 360 is at a higher voltage.

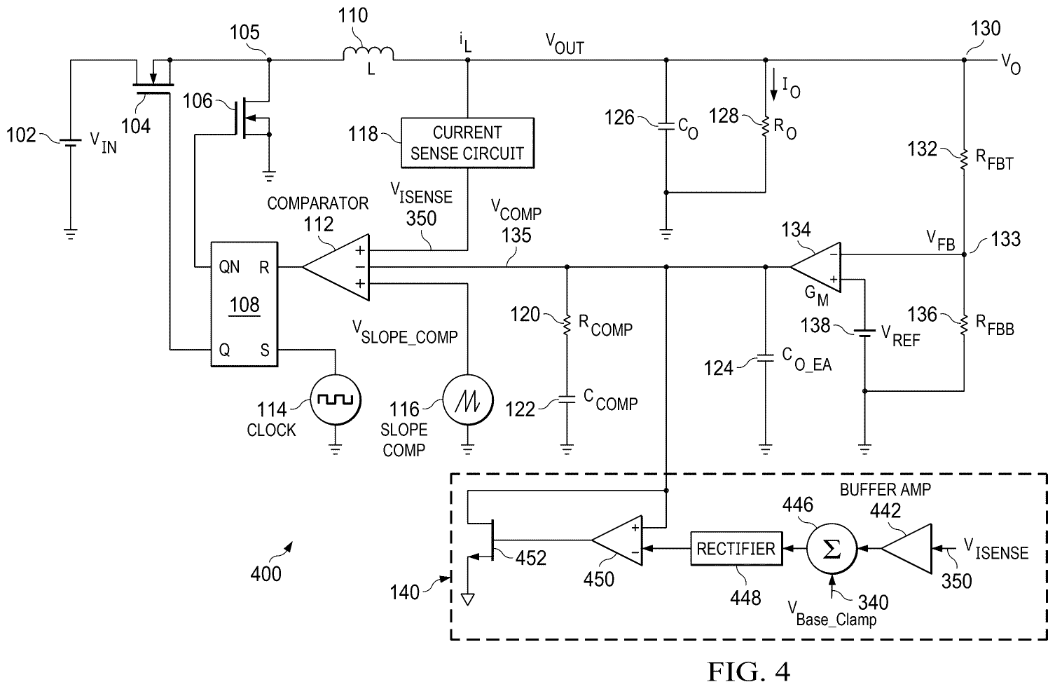

FIG. 4 shows a schematic diagram for an example switching voltage regulator 400 having a dynamic voltage clamp circuit. Input voltage source 102 provides an input voltage V_{IN}. Transistor 104 is coupled between input voltage source 102 and a switching terminal 105, and acts as a high-side switch for the voltage regulator. Transistor 106 is coupled between the switching terminal 105 and a ground terminal, and acts as a low-side switch for the voltage regulator. Inductor 110 is coupled between the switching terminal 105 and an output voltage terminal V_{O} 130. A current I_{L} runs through inductor 110. Capacitor C_{O} 126 and resistor R_{O} 128 are coupled in parallel between the output voltage terminal V_{O} 130 and the ground terminal. Capacitor C_{O} 126 and resistor R_{O} 128 represent the load capacitance and load resistance, respectively, on the output.

Resistor 132 is coupled between the output voltage terminal V_{O} 130 and an output voltage feedback terminal 133. Resistor 136 is coupled between the output voltage feedback terminal 133 and the ground terminal. Resistors 132 and 136 form a voltage divider on the output voltage V_{O} 130. The voltage at the output voltage feedback terminal 133 is V_{FB}. The inverting input of amplifier 134 is coupled to the output voltage feedback terminal 133 and receives the voltage V_{FB}. Reference voltage source 138 is coupled between the noninverting input of amplifier 134 and the ground terminal, and provides a reference voltage V_{REF}. The voltage V_{REF} is a reference voltage representing the specified nominal output voltage for switching voltage regulator 400.

In at least one example, amplifier 134 is a transconductance amplifier. Amplifier 134 compares the voltage V_{FB} at the output voltage feedback terminal 133 to the reference voltage V_{REF}, and provides at its output a current that is proportional to the difference between V_{FB} and V_{REF}. Clamp circuit 140 is coupled between the output of amplifier 134 and the ground terminal. The purpose of clamp circuit 140 is to ensure that the compensation voltage V_{COMP} 135 does not exceed a clamping voltage V_{Clamp} that is dynamically generated in clamp circuit 140. The clamp voltage V_{Clamp} is equal to a fixed voltage summed with a scaled version of the sensed inductor current, V_{ISENSE} 350.

Current sense circuit 118 is coupled between the output voltage terminal V_{O} 130 and a first noninverting input of comparator 112. Current sense circuit 118 senses the current flowing through inductor 110 and provides a voltage V_{ISENSE} 350 that is proportional to the current through inductor 110. Slope Comp generator 116 is coupled between a second noninverting input of comparator 112 and the ground terminal. Slope Comp generator 116 provides a slope compensation waveform at the frequency of the switching voltage regulator.

The current sense signal V_{ISENSE} 350 from current sense circuit 118 is summed with the slope compensation waveform from Slope Comp generator 116 to make up the noninverting input to comparator 112. The output of amplifier 134 is coupled to the inverting input of comparator 112 providing the signal V_{COMP} 135 at the inverting input of comparator 112. Resistor R_{COMP} 120 is coupled between the output of amplifier 134 and a first terminal of capacitor C_{COMP} 122. A second terminal of capacitor C_{COMP} 122 is coupled to the ground terminal. Capacitor C_{O_EA} 124 is coupled between the output of amplifier 134 and the ground terminal. Resistor R_{COMP} 120, capacitor C_{COMP} 122, and capacitor C_{O_EA} 124 form a type II compensation filter, which is commonly used in current mode control circuits.

Capacitor C_{COMP} 122 sets the crossover frequency of the type II compensation filter. Resistor R_{COMP} 120 is coupled in series with capacitor C_{COMP} 122 and provides a zero in the type II compensation filter. Capacitor C_{O_EA} 124 usually has a small capacitance value (e.g. 10 pF), and is used primarily for filtering out high frequency noise rather than for providing stability to the control loop. Stability for the control loop is provided primarily by the capacitor C_{COMP} 122 and resistor R_{COMP} 120.

Comparator 112 is shown as having 3 inputs, but could also be shown as having a summing terminal coupled to a single noninverting input to comparator 112 in which the current sense signal V_{ISENSE} 350 is summed with the slope compensation wave VSLOPE COMP from Slope Comp generator 116, and provided as the noninverting input to comparator 112. Comparator 112 compares this summed signal to the compensation voltage V_{COMP} 135, and provides an output signal to the Reset input of latch 108. In at least one example, latch 108 is an RS flip-flop.

Clock generator 114 is coupled between the Set input of latch 108 and the ground terminal. Clock generator provides a square-wave signal having the same frequency as the switching frequency of switching voltage regulator 400. The square-wave signal produced by clock generator 114 has the same frequency and is in phase with the slope compensation waveform VSLOPE COMP produced by Slope Comp generator 116.

The Q output of latch 108 is coupled to the control terminal of transistor 104 and controls the turning on and turning off of transistor 104. The QN output of latch 108, which is an inverted version of the Q output, is coupled to the control terminal of transistor 106 and controls the turning on and turning off of transistor 106. In many examples, an additional first drive stage (not shown) and second drive stage (not shown) would be coupled between the Q output of latch 108 and the control terminal of transistor 104, and between the QN output of latch 108 and the control terminal of transistor 106, respectively, to ensure that enough current is provided to the control terminals of transistor 104 and 106, respectively, to turn them on.

Clamp circuit 140 includes buffer amplifier 442, summer 446, rectifier 448, amplifier 450, and transistor 452. Rectifier 448 may be omitted in some example systems. Buffer amplifier 442 has an input coupled to the output of current sense circuit 118 that receives the signal V_{ISENSE} 350. The output of buffer amplifier 442 is coupled to a first input of summer 446, which receives the buffered version of V_{ISENSE} 350. A second input of summer 446 receives a constant voltage V_{Base_Clamp} 340, which is equal to the sum of V_{COMP_Offset} 310, V_{MAX_Slope_Comp} 320, and the safety margin voltage V_{margin} 330.

The output of summer 446 is coupled to the input of rectifier 448. The output of rectifier 448 is coupled to the inverting input of amplifier 450. Rectifier 448 is omitted in some example systems, in which case the output of summer 446 is coupled directly to the inverting input of amplifier 450. Rectifying the inductor current may improve performance because adding the peak inductor current to V_{Base_Clamp} 340 provides the most accurate clamp voltage V_{Clamp} 360. Ideally, the clamp voltage V_{Clamp} 360 tracks the peak inductor current, which is provided by rectifying the inductor current sense signal. However, rectifying the inductor current sense signal is not required.

In this description, “terminal,” “node,” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, “ground” includes a chassis ground, an Earth ground, a floating ground, a virtual ground, a digital ground, a common ground and/or any other form of ground connection applicable to, or suitable for, the teachings of this description.

In this description, the term “couple” may cover connections, communications or signal paths that enable a functional relationship consistent with this description. For example, if device A generates a signal to control device B to perform an action, then: (a) in a first example, device A is coupled to device B by direct connection; or (b) in a second example, device A is coupled to device B through intervening component C if intervening component C does not alter the functional relationship between device A and device B, so device B is controlled by device A via the control signal generated by device A.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

What is claimed is:

1. A voltage regulator circuit, comprising:
an amplifier having first and second amplifier inputs and an amplifier output, wherein the first amplifier input is coupled to a feedback voltage terminal, and the second amplifier input is coupled to a reference voltage terminal;
a comparator having first and second comparator inputs and a comparator output, wherein the first comparator input is coupled to the amplifier output;
a current sense circuit having a current sense input and a current sense output, wherein the current sense input is coupled to an output voltage terminal, the current sense output is coupled to the second comparator input, and the current sense circuit is configured to provide at the current sense output a current sense voltage proportional to a current being delivered to the output voltage terminal;
a waveform generator coupled between the second comparator input and a ground terminal, wherein the waveform generator is configurable to provide a waveform signal at a switching frequency;
a latch having first and second latch inputs and first and second latch outputs, wherein the first latch input is coupled to the comparator output;
a clock generator coupled between the second latch input and the ground terminal, the clock generator being configurable to provide a clock signal at the switching frequency; and
a voltage clamp circuit having first and second voltage clamp inputs and a voltage clamp output, wherein the first voltage clamp input is coupled to the current sense output, the second voltage clamp input is coupled to a fixed voltage source, the voltage clamp output is coupled to the first comparator input, and the voltage clamp circuit is configurable to limit a voltage at the first comparator input to a clamp voltage that varies in response to the current sense voltage.

2. The voltage regulator circuit of claim 1, wherein the waveform signal is a sawtooth waveform.

3. The voltage regulator circuit of claim 1, wherein the waveform signal and the clock signal are in phase.

4. The voltage regulator circuit of claim 1, wherein the latch is a flip-flop, the first latch input is a reset input, and the second latch input is a set input.

5. The voltage regulator circuit of claim 1, wherein the fixed voltage source provides a fixed voltage that is a sum of a maximum voltage of the waveform signal and a minimum voltage at the first comparator input required to trigger switching in the latch.

6. The voltage regulator circuit of claim 1, wherein the voltage regulator circuit is further comprising:
a resistor and a first capacitor coupled in series between the first comparator input and the ground terminal; and
a second capacitor coupled between the first comparator input and the ground terminal.

7. The voltage regulator circuit of claim 6, wherein the amplifier is a first amplifier, the amplifier output is a first amplifier output, and the voltage clamp circuit includes:
a buffer having a buffer input and a buffer output, wherein the buffer input is coupled to the current sense output;
a summer having first and second summer inputs and a summer output, wherein the first summer input is coupled to the buffer output, and the second summer input is coupled to the fixed voltage source;
a second amplifier having third and fourth amplifier inputs and a second amplifier output, wherein the third amplifier input is coupled to the summer output, and the fourth amplifier input is coupled to the first comparator input; and
a transistor coupled between the fourth amplifier input and the ground terminal.

8. The voltage regulator circuit of claim 7, further comprising a rectifier circuit coupled between the summer output and the third amplifier input.

9. The voltage regulator circuit of claim 7, wherein the fixed voltage source provides a fixed voltage that is a sum of a maximum voltage of the waveform signal and a minimum voltage at the first comparator input required to trigger switching in the latch.

10. The voltage regulator circuit of claim 1, further comprising:
a first transistor coupled between an input voltage source and a switching terminal, and having a first control terminal coupled to the first latch output; and
a second transistor coupled between the switching terminal and the ground terminal, and having a second control terminal coupled to the second latch output.

11. The voltage regulator circuit of claim 10, further comprising an inductor coupled between the switching terminal and the output voltage terminal.

12. The voltage regulator circuit of claim 11, further comprising:
a first resistor coupled between the output voltage terminal and the feedback voltage terminal; and
a second resistor coupled between the feedback voltage terminal and the ground terminal.

13. A method for controlling a voltage converter circuit, comprising:
connecting a first field effect transistor (FET) in series with a second FET between an input voltage terminal and a ground terminal;
coupling an inductor between a switching terminal and an output voltage terminal, wherein the output voltage terminal provides an output voltage, and the first and second FETs are connected at the switching terminal;
generating, at a compensation terminal, a current that is proportional to a difference between a reference voltage and a voltage that is proportional to the output voltage, which produces a compensation voltage that tracks a current through the inductor;
generating a waveform signal and a clock signal that each have a same frequency and are in-phase;
limiting the compensation voltage to not exceed a clamping voltage, wherein the clamping voltage is equal to a sum of a maximum voltage of the waveform signal, a minimum compensation voltage required to trigger switching of the first and second FETs, and a current sense voltage that is proportional to a current through the inductor;
comparing the compensation voltage to a comparison voltage using a comparator having a comparator output, wherein the comparison voltage is equal to a sum of the maximum voltage of the waveform signal and the minimum compensation voltage that is required to trigger switching of the first and second FETs; and
controlling the first and second FETs responsive to the comparator output.

14. The method of claim 13, wherein limiting the compensation voltage includes:
providing the current sense voltage to a first input of a summing circuit having a summer output;
providing a constant voltage to a second input of the summing circuit, wherein the constant voltage includes a maximum voltage of the waveform signal and a minimum compensation voltage required to trigger switching of the first and second FETs; and
coupling the summer output to a first input of an amplifier, and coupling the compensation terminal to a second input of an amplifier; and
coupling a transistor between the compensation terminal and a ground terminal, and coupling an output of the amplifier to a control terminal of the transistor.

15. The method of claim 14, wherein limiting the compensation voltage further includes coupling an input of a rectifier circuit to the summer output, and coupling the output of the rectifier circuit to the first input of the amplifier.

16. The method of claim 14, wherein the current sense voltage is buffered using a buffer amplifier prior to being provided to the first input of the summing circuit.

17. The method of claim 13, further comprising filtering the compensation voltage using a compensation filter.

18. The method of claim 17, wherein the compensation filter includes at least one pole and one zero.

19. The method of claim 13, wherein the waveform signal is a sawtooth waveform.

20. The method of claim 19, wherein the voltage converter circuit is a buck voltage converter circuit.
